(19) United States
(12) Patent Application Publication
(10) Pub. No.: US 2017/0372452 A1
(43) Pub. Date: Dec. 28, 2017

(54) IMAGE ROTATION METHOD AND APPARATUS

(71) Applicant: QUALCOMM Incorporated, San Diego, CA (US)

(72) Inventor: Chun Wang, Markham (CA)

(21) Appl. No.: 15/189,956

(22) Filed: Jun. 22, 2016

(51) Int. Cl. G06T 3/60; G06T 1/20

(52) U.S. Cl. CPC G06T 3/60; G06T 1/20

(57) ABSTRACT

This disclosure describes an apparatus and techniques for rotating image data. The rotation techniques may include fetching a strip of a block of image data from an external memory, writing the strip into a strip buffer in a first scan direction, reading a micro-block of pixels of the strip in the strip buffer in the first scan direction and writing the micro-block into a rotation buffer in the first scan direction, and rotating the micro-block of pixels by reading the micro-block of pixels in the rotation buffer in a second scan direction, the second scan direction different from the first scan direction, and writing the micro-block of pixels into a rotation memory in the second scan direction.

### TECHNICAL FIELD

The disclosure relates to display processing and image rotation.

### BACKGROUND

Visual content for display, such as content for graphical user interfaces and video games, may be generated by a graphics processing unit (GPU), a video decoder, a central processing unit (CPU), or other processing devices. Such content may be in the form an image or surface. Rotation of such content may be performed when the scan direction of an image is different than the scan direction of a display panel to which the content is to be displayed. For example, a display panel may be configured for portrait scan, while video content may be arranged in a landscape orientation.

Mobile devices commonly rotate content for display. This is because mobile devices may be held by a user at multiple different angles and orientations. The orientation at which a mobile device is held may specify how an image is to be displayed. If the orientation of the mobile device differs from the orientation of the image to be displayed (e.g., causing mismatch in the image scan direction and the display scan direction), the mobile device may first rotate the image before displaying the image.

### SUMMARY

Techniques of this disclosure relate to display processing and image rotation. Visual content may be generated or processed by a central processing unit (CPU), a graphics processing unit (GPU), a digital signal processor (DSP), a video processing unit, a camera processing unit, an image processing unit, a pixel processing unit, and/or another source. A processor (e.g., a display processor) may be configured to receive visual content from any source. In accordance with the techniques of this disclosure, such a processor may include a rotation engine configured to rotate the image. The rotation image may employ a hierarchical image dividing technique, using increasingly smaller buffers, to rotate small sub-divisions (e.g., micro-blocks) of an image. As will be explained in more detail below, such a rotation technique may be referred to as micro rotation.

In one example, this disclosure describes a method for processing image data, the method comprising fetching a strip of a block of image data from an external memory, writing the strip into a strip buffer in a first scan direction, reading a micro-block of pixels of the strip in the strip buffer in the first scan direction and writing the micro-block into a rotation buffer in the first scan direction, and rotating the micro-block of pixels by reading the micro-block of pixels in the rotation buffer in a second scan direction, the second scan direction different from the first scan direction, and writing the micro-block of pixels into a rotation memory in the second scan direction.

In another example, this disclosure describes an apparatus configured to process image data, the apparatus comprising an external memory configured to store image data, and a display processor comprising a strip buffer, a rotation buffer, and a rotation memory, the display processor configured to fetch a strip of a block of the image data from the external memory, write the strip into the strip buffer in a first scan direction, read a micro-block of pixels of the strip in the strip buffer in the first scan direction and write the micro-block into the rotation buffer in the first scan direction, and rotate the micro-block of pixels by reading the micro-block of pixels in the rotation buffer in a second scan direction, the second scan direction different from the first scan direction, and write the micro-block of pixels into the rotation memory in the second scan direction.

In another example, this disclosure describes an apparatus configured to for process image data, the apparatus comprising means for fetching a strip of a block of image data from an external memory, means for writing the strip into a strip buffer in a first scan direction, means for reading a micro-block of pixels of the strip in the strip buffer in the first scan direction, means for writing the micro-block into a rotation buffer in the first scan direction, means for rotating the micro-block of pixels by reading the micro-block of pixels in the rotation buffer in a second scan direction, the second scan direction different from the first scan direction, and means for writing the micro-block of pixels into a rotation memory in the second scan direction.

In another example, this disclosure describes a computer-readable storage medium storing instructions that, when executed, cause one or more processors of a device for processing image data to fetch a strip of a block of image data from an external memory, write the strip into a strip buffer in a first scan direction, read a micro-block of pixels of the strip in the strip buffer in the first scan direction and write the micro-block into a rotation buffer in the first scan direction, and rotate the micro-block of pixels by reading the micro-block of pixels in the rotation buffer in a second scan direction, the second scan direction different from the first scan direction, and write the micro-block of pixels into a rotation memory in the second scan direction.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may be configured to implement one or more aspects of this disclosure.

FIG. 2 is a conceptual diagram illustrating image rotation.

FIG. 3 is a block diagram illustrating an example display processor that may be configured to implement one or more aspects of this disclosure.

FIG. 4 is a conceptual diagram illustrating a hierarchical image rotation technique according to one example of this disclosure.

FIG. 5 is a block diagram illustrating an image rotation engine according to one example of this disclosure.

FIG. 6 is a conceptual diagram illustrating example micro rotation read and write directions for NV12 data.

FIG. 7 is a conceptual diagram illustrating example micro rotation read and write directions for aRGB data.

FIG. 8 is a conceptual diagram illustrating example micro rotation read and write directions for YUV422 data.

FIG. 9 is a conceptual diagram illustrating example micro rotation read and write directions for P010 data.

FIG. 10 is a conceptual diagram illustrating read and write directions for a main rotator buffer.

FIG. 11 is a conceptual diagram illustrating example main rotation memory read and write directions for NV12 data.

FIG. 12 is a conceptual diagram illustrating example main rotation memory read and write directions for aRGB data.

FIG. 13 is a conceptual diagram illustrating example main rotation memory read and write directions for YUV422 data.

FIG. 14 is a conceptual diagram illustrating example main rotation memory read and write directions for P010 data.

FIG. 15 is a flowchart illustrating an example method according to one or more aspects of the disclosure.

### DETAILED DESCRIPTION

Image rotation is a common task performed by display processors in mobile devices. In particular, the user interface, or other visual content, displayed on a mobile device may require rotation depending on how the device is oriented by the user. An image rotation engine may take a significant amount of chip area (e.g., 20%) in some example display processors. As new functionalities, such as new video formats (e.g., 10 bit deep color video) and universal bandwidth compression (UBWC), are added to mobile devices, the image rotation engine, using existing image rotation techniques, may need to be expanded in area to accommodate such new features. However, increasing the size of the image rotation engine, or the size of a display processor accommodating such an image rotation engine, is undesirable.

To be able to add new functionality to a mobile device, without adding area to (or even reducing area of) the image rotation engine, this disclosure describes a hierarchical image rotation engine and image rotation technique. The hierarchical image rotation techniques of this disclosure may be referred to as micro rotation. In general, an image is divided into hierarchical (smaller and smaller) sub-divisions. The rotation hardware is implemented for each incremental hierarchical division (from lowest sub-division of a pixel upward to full image). The divided, hierarchical steps may improve the ability to map each rotation step into more optimal hardware logic. The image rotation engine described in this disclosure, compared with other example image rotation engines, may be able to reduce chip area, reduce the number of memory units, and reduce power consumption.

As used herein, the term “image” is not intended to mean only a still image. Rather, an image or image layer may be associated with a still image (e.g., the image or image layers when blended may be the image) or a video (e.g., the image or image layers when blended may be a single image in a sequence of images that when viewed in sequence create a moving picture or video).

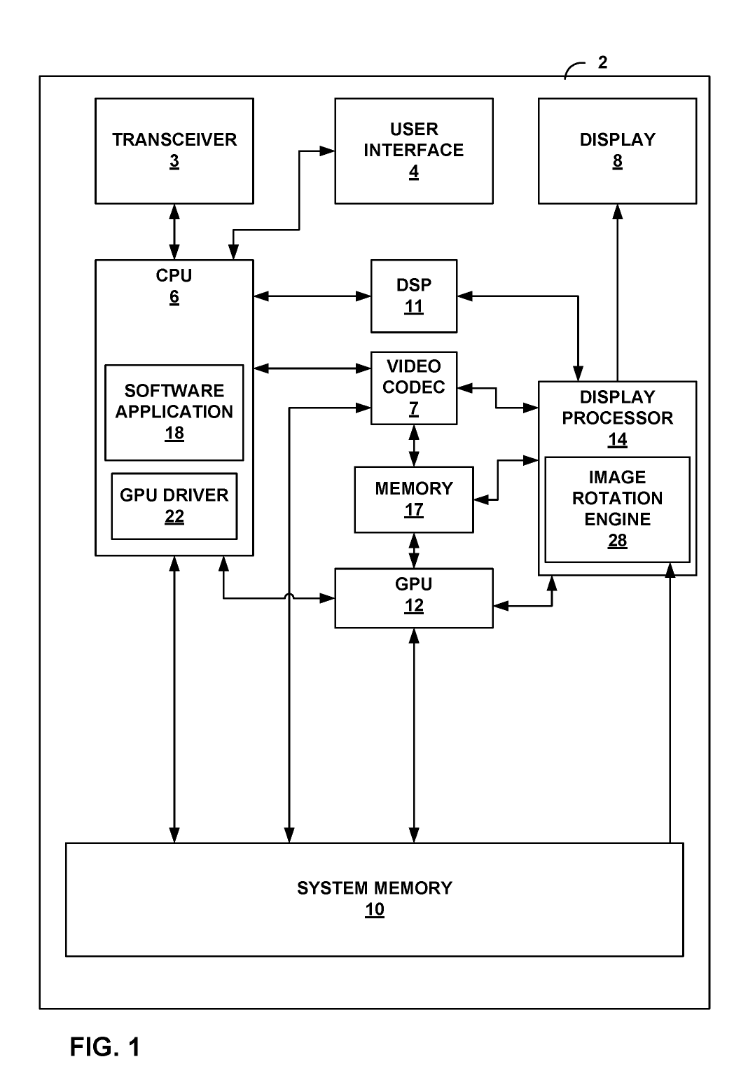

FIG. 1 is a block diagram illustrating an example computing device that may be configured to implement one or more image rotation techniques of this disclosure. As shown in FIG. 1, computing device 2 may be a computing device including, but not limited to, video devices, media players, set-top boxes, wireless handsets such as mobile telephones and so-called smartphones, personal digital assistants (PDAs), wearable computing devices, desktop computers, laptop computers, gaming consoles, video conferencing units, tablet computing devices, and the like. In some examples, computing device 2 may be a mobile communication device. In the example of FIG. 1, computing device 2 may include central processing unit (CPU) 6, system memory 10, and GPU 12. Computing device 2 may also include digital signal processor (DSP) 11, display processor 14, transceiver 3, user interface 4, video codec 7, and display device 8. In some examples, video codec 7 may be a software application, such as a software application 18 configured to be processed by CPU 6. In other examples, video codec 7 may be a hardware component different from CPU 6, a software application that runs on a component different from CPU 6, or a combination of hardware and software.

The configuration of computing device 2 in FIG. 1 is exemplary. In other examples, display processor 14 may be configured to receive visual content from any source, such as any CPU (e.g., CPU 6), any GPU (e.g., GPU 12), any DSP, any video processing unit, any camera processing unit, any image processing unit, any pixel processing unit, any memory storing visual content, or any other source. As one example, display processor 14 may be configured to receive visual content data from another device (e.g., another computing device 2, a server, or any device different from computing device 2 to which computing device 2 may be configured to permanently or temporarily communicatively couple). In such an example, computing device 2 may receive visual content at transceiver 3. Display processor 14 may be configured to process visual content received by transceiver 3. In some examples, display processor 14 may receive visual content directly from transceiver 3. In other examples, display processor 14 may receive visual content received by transceiver 3 from CPU 6, GPU 12, or any other processing unit of computing device 2. In such examples, display processor 14 may receive visual content as it was received by transceiver 3 or as further processed visual content by, for example, CPU 6, GPU 12, or any other processing unit of computing device 2.

As used herein, the term “visual content” includes but is not limited to any graphics data, graphical data, video data, image data, pixel data, graphics content, graphical content, video content, a frame of video data, a surface, image content, and/or pixel content.

In view of the various sources of visual content accessible by display processor 14, display processor 14 may be configured to perform any technique for image rotation described herein with respect to any source of visual content (e.g., any processing unit or any memory storing visual content). In the example of FIG. 1, display processor 14 includes image rotation engine 28 configured to perform the hierarchical, micro rotation techniques of this disclosure. However, it should be understood that image rotation engine 28 may be separate from display processor 14 (e.g., an application specific integrated circuit (ASIC)) or may be implemented in another processing device, such as video codec 7, DSP 11, GPU 12, or any other processor.

Display processor 14 may utilize a tile-based architecture. In other examples, display processor 14 may utilize a line-based architecture. In such examples, display processor 14 may be configured to implement one or more techniques of this disclosure for line-based display processing as well as tile-based display processing. In some examples, a tile is an area representation of pixels comprising a height and width. In such examples, tiles may be rectangular or square in nature. In other examples, a tile may be a shape different than a square or a rectangle. Display processor 14 may pre-fetch or fetch tiles of an image for processing. Example processing that may be performed by display processor 14 may include up-sampling, down-sampling, scaling, rotation, and other pixel processing. Display processor 14 may also blend pixels from multiple images, and write back the blended pixels into memory in tile format.

Video codec (coder/decoder) 7 may receive encoded video data. Computing device 2 may receive encoded video data from a source device (e.g., a device that encoded the data or otherwise transmitted the encoded video data to computing device 2, such as a server). In other examples, computing device 2 may itself generate the encoded video data. For example, computing device 2 may include a camera for capturing still images or video. The captured data (e.g., video data) may be encoded by video codec 7. Encoded video data may include a variety of syntax elements generated by a video encoder for use by a video decoder, such as video codec 7, in decoding the video data. While video codec 7 is described herein as being both a video encoder and video decoder, it is understood that video codec 7 may be a video decoder without encoding functionality in other examples.

Video data decoded by video codec 7 may be sent directly to display processor 14, may be sent directly to display 8, or may be sent to memory accessible to display processor 14 or GPU 12 such as system memory 10, or memory 17. In some examples, memory 17 may be a frame buffer. In the example shown, video codec 7 is connected to display processor 14, meaning that decoded video data is sent directly to display processor 14 and/or stored in memory accessible to display processor 14. In such an example, display processor 14 may issue one or more memory requests to obtain decoded video data from memory in a similar manner as when issuing one or more memory requests to obtain graphical (still image or video) data from memory (e.g., memory 17) associated with GPU 12. In accordance with examples of this disclosure, display processor 14 may be configured to rotate frames of video data.

System memory 10 and memory 17 may be formed by any of a variety of memory devices, such as dynamic random access memory (DRAM), including synchronous DRAM (SDRAM), double data rate (DDR) SDRAM, magnetoresistive RAM (MRAM), resistive RAM (RRAM), or other types of memory devices. System memory 10 and memory 17 may be provided by the same memory device or separate memory devices.

Transceiver 3, video codec 7, and display processor 14 may be part of the same integrated circuit (IC) as CPU 6 and/or GPU 12, may be external to the IC or ICs that include CPU 6 and/or GPU 12, or may be formed in the IC that is external to the IC that includes CPU 6 and/or GPU 12. For example, video codec 7 may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof.

CPU 6 may be a microprocessor, such as a central processing unit (CPU) configured to process instructions of a computer program for execution. CPU 6 may comprise a general-purpose or a special-purpose processor that controls operation of computing device 2. A user may provide input to computing device 2 to cause CPU 6 to execute one or more software applications, such as software application 18. The software applications (e.g., software application 18) that execute on CPU 6 may include, for example, an operating system, a word processor application, an email application, a spreadsheet application, a media player application, a video game application, a graphical user interface application, or another type of software application that uses graphical data for 2D or 3D graphics. Additionally, CPU 6 may execute GPU driver 22 for controlling the operation of GPU 12. The user may provide input to computing device 2 via one or more input devices (not shown) such as a keyboard, a mouse, a microphone, a touch pad or another input device that is coupled to computing device 2 via user interface 4.

Software application 18 that execute on CPU 6 may include one or more graphics rendering instructions that instruct CPU 6 to cause the rendering of graphics data to display device 8. The instructions may include instructions to process 3D graphics as well as instructions to process 2D graphics. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, an Open Computing Language (OpenCL™) or any other public or proprietary standard GPU compute API. In order to process the graphics rendering instructions of software application 18 executing on CPU 6, CPU 6, during execution of software application 18, may issue one or more graphics rendering commands to GPU 12 (e.g., through GPU driver 22) to cause GPU 12 to perform some or all of the rendering of the graphics data. In some examples, the graphics data to be rendered may include a list of graphics primitives, e.g., points, lines, triangles, quadrilaterals, triangle strips, etc.

Software application 18 may include one or more drawing instructions that instruct GPU 12 to render a graphical user interface (GUI), a graphics scene, graphical data, or other graphics related data. For example, the drawing instructions may include instructions that define a set of one or more graphics primitives to be rendered by GPU 12. In some examples, the drawing instructions may, collectively, define all or part of a plurality of windowing surfaces used in a GUI. In additional examples, the drawing instructions may, collectively, define all or part of a graphics scene that includes one or more graphics objects within a model space or world space defined by the application.

GPU 12 may be configured to perform graphics operations to render one or more graphics primitives to display device 8. Thus, when software applications 18 executing on CPU 6 requires graphics processing, CPU 6 may provide graphics rendering commands along with graphics data to GPU 12 for rendering to display device 8. The graphics data may include, e.g., drawing commands, state information, primitive information, texture information, etc. GPU 12 may, in some instances, be built with a highly-parallel structure that provides more efficient processing of complex graphic-related operations than CPU 6. For example, GPU 12 may include a plurality of processing elements, such as shader units, that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display device 8 more quickly than drawing the scenes directly to display device 8 using CPU 6.

Software application 18 may invoke GPU driver 22, to issue one or more commands to GPU 12 for rendering one or more graphics primitives into displayable graphics images (e.g., displayable graphical data). For example, software application 18 may invoke GPU driver 22 to provide primitive definitions to GPU 12. In some instances, the primitive definitions may be provided to GPU 12 in the form of a list of drawing primitives, e.g., triangles, rectangles, triangle fans, triangle strips, etc. The primitive definitions may include vertex specifications that specify one or more vertices associated with the primitives to be rendered. The vertex specifications may include positional coordinates for each vertex and, in some instances, other attributes associated with the vertex, such as, e.g., color coordinates, normal vectors, and texture coordinates. The primitive definitions may also include primitive type information (e.g., triangle, rectangle, triangle fan, triangle strip, etc.), scaling information, rotation information, and the like.

Based on the instructions issued by software application 18 to GPU driver 22, GPU driver 22 may formulate one or more commands that specify one or more operations for GPU 12 to perform in order to render the primitive. When GPU 12 receives a command from CPU 6, a graphics processing pipeline may execute on shader processors of GPU 12 to decode the command and to configure a graphics processing pipeline to perform the operation specified in the command. For example, an input-assembler in the graphics processing pipeline may read primitive data and assemble the data into primitives for use by the other graphics pipeline stages in a graphics processing pipeline. After performing the specified operations, the graphics processing pipeline outputs the rendered data to memory 17 accessible to display processor 14. In some examples, the graphics processing pipeline may include fixed function logic and/or be executed on programmable shader cores.

Memory 17 stores destination pixels for GPU 12. Each destination pixel may be associated with a unique screen pixel location. Memory 17 may be considered a frame buffer associated with video codec 7. In some examples, memory 17 may store color components and a destination alpha value for each destination pixel. For example, memory 17 may store pixel data according to any format. For example, memory 17 may store Red, Green, Blue, Alpha (RGBA) components for each pixel where the “RGB” components correspond to color values and the “A” component corresponds to a destination alpha value. As another example, memory 17 may store pixel data according to the YCbCr color format, YUV color format, RGB color format, or according to any other color format. Although output memory 17 and system memory 10 are illustrated as being separate memory units, in other examples, memory 17 may be part of system memory 10. For example, memory 17 may be allocated memory space in system memory 10. Memory 17 may constitute a frame buffer. Further, as discussed above, memory 17 may also be able to store any suitable data other than pixels.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. In some examples, GPU 12 may be on-chip with CPU 6, such as in a system on chip (SOC) GPU 12 may include one or more processors, such as one or more microprocessors, application specific integrated circuits (ASICs), field programmable gate arrays (FPGAs), digital signal processors (DSPs), or other equivalent integrated or discrete logic circuitry. GPU 12 may include fixed function and/or programmable processing circuity. For example, GPU 12 may also include one or more processor cores, so that GPU 12 may be referred to as a multi-core processor.

In some examples, GPU 12 may store a fully formed image in system memory 10. Display processor 14 may retrieve the image from system memory 10 and/or memory 17 and output values that cause the pixels of display device 8 to illuminate to display the image. In some examples, display processor 14 may be configured to perform 2D operations on data to be displayed, including the rotation techniques described in this disclosure.

Display device 8 may be the display of computing device 2 that displays the image content generated by GPU 12. Display device 8 may be a liquid crystal display (LCD), an organic light emitting diode display (OLED), a cathode ray tube (CRT) display, a plasma display, or another type of display device. In some examples, display 8 may be integrated within computing device 2. For instance, display 8 may be a screen of a mobile telephone. In other examples, display 8 may be a stand-alone device coupled to computing device 2 via a wired or wireless communications link. For example, display 8 may be a computer monitor or flat panel display connected to a computing device (e.g., personal computer, mobile computer, tablet, mobile phone, etc.) via a cable or wireless link.

Computing device 2 may include additional modules or processing units not shown in FIG. 1 for purposes of clarity. For example, computing device 2 may include a speaker and a microphone, neither of which are shown in FIG. 1, to effectuate telephonic communications in examples where computing device 2 is a mobile wireless telephone, or a speaker where computing device 2 is a media player. Computing device 2 may also include a camera. Furthermore, the various modules and units shown in computing device 2 may not be necessary in every example of computing device 2. For example, user interface 4 and display device 8 may be external to computing device 2 in examples where computing device 2 is a desktop computer or other device that is equipped to interface with an external user interface or display.

Examples of user interface 4 include, but are not limited to, a trackball, a mouse, a keyboard, and other types of input devices. User interface 4 may also be a touch screen and may be incorporated as a part of display device 8. Transceiver 3 may include circuitry to allow wireless or wired communication between computing device 2 and another device or a network. Transceiver 3 may include modulators, demodulators, amplifiers and other such circuitry for wired or wireless communication. In some examples, transceiver 3 may be integrated with CPU 6.

Display processor 14 may implement various techniques described herein to, for example, perform rotation on images produced by the components of computing device. Various other benefits may also be derived from techniques described herein. As will be explained in more detail below, display processor 14 may be configured to fetch a strip of a block of image data from an external memory, write the strip into a strip buffer in a first scan direction, read a micro-block of pixels of the strip in the strip buffer in the first scan direction and write the micro-block into a micro rotation buffer in the first scan direction, and rotate the micro-block of pixels by reading the micro-block of pixels in the micro rotation buffer in a second scan direction, the second scan direction different from the first scan direction, and write the micro-block of pixels into a main rotation memory in the second scan direction.

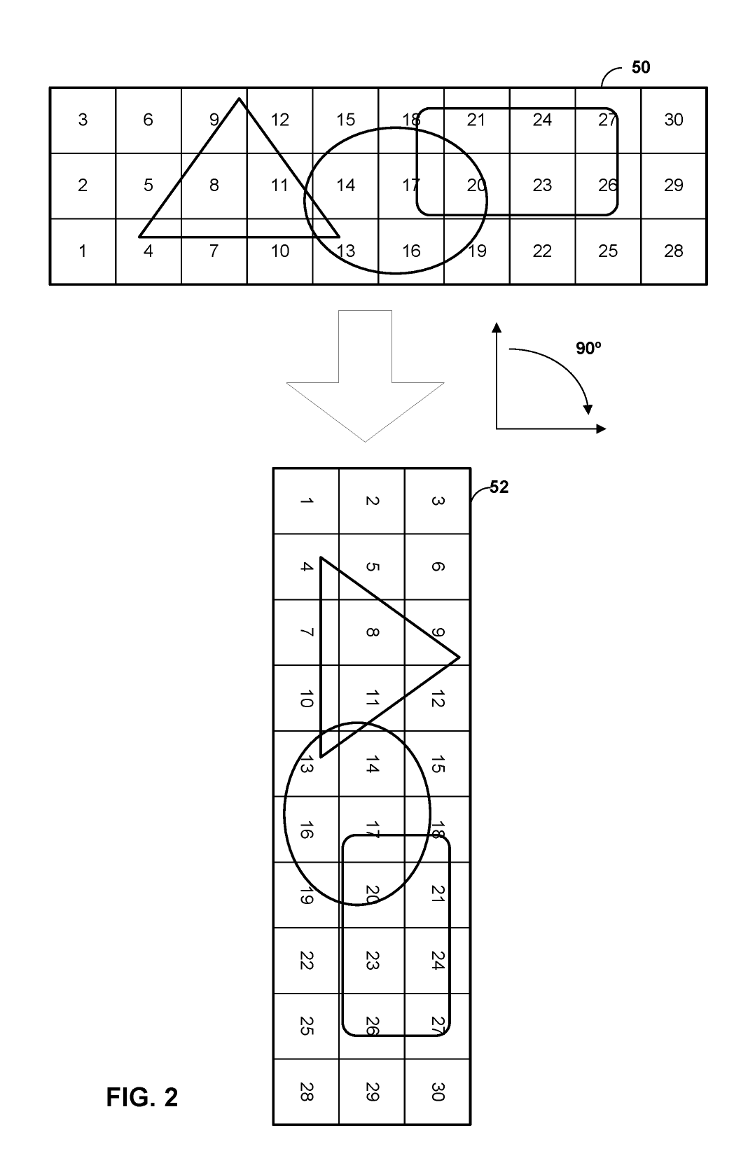

FIG. 2 is a conceptual diagram illustrating image rotation. As shown in FIG. 2, an input image 50 is rotated by 90 degrees, clockwise to produce rotated image 52. As discussed above, in some examples, input image 50 may be divided into blocks and display processor 14 may be configured to perform processing, including rotation, on each block of the image. As shown in FIG. 2, both input image 50 and rotated image 52 are divided into 28 blocks. The number of each block indicates the order in which the blocks are processed. The block ordering in FIG. 2 is just an example, and other block ordering may be used.

In some examples, a display processor may be configured to access the pixel values of an entire block in one scan direction (e.g., a horizontal raster scan direction) and store the entire block in the display processor. The display processor may then be configured to write the stored block to external memory in a different scan direction (e.g., a vertical raster scan direction). By writing the block back out to memory in a different scan direction than was used to read the block, the block becomes rotated. Such a process may be repeated for every block.

Such techniques for rotating images may require a large number of memory buffers in the display processor. The needed memory buffers must be large enough to store two blocks worth of pixel data for four different color channels (e.g., RGBa). Storage for two blocks worth of pixel data may be needed so that one memory bank may read in block data, while another memory bank reads out block data. Furthermore, in such a system, it may be beneficial to use more complex and costly dual ported memory so that read and write processes may be performed on the same memory bank at the same time. This requirement for a large amount of memory becomes exacerbated as the bit depth of images becomes larger, e.g., by introducing high bit-depth video coding or UBWC. UBWC is a compression technique to reduce the amount of memory needed to store data.

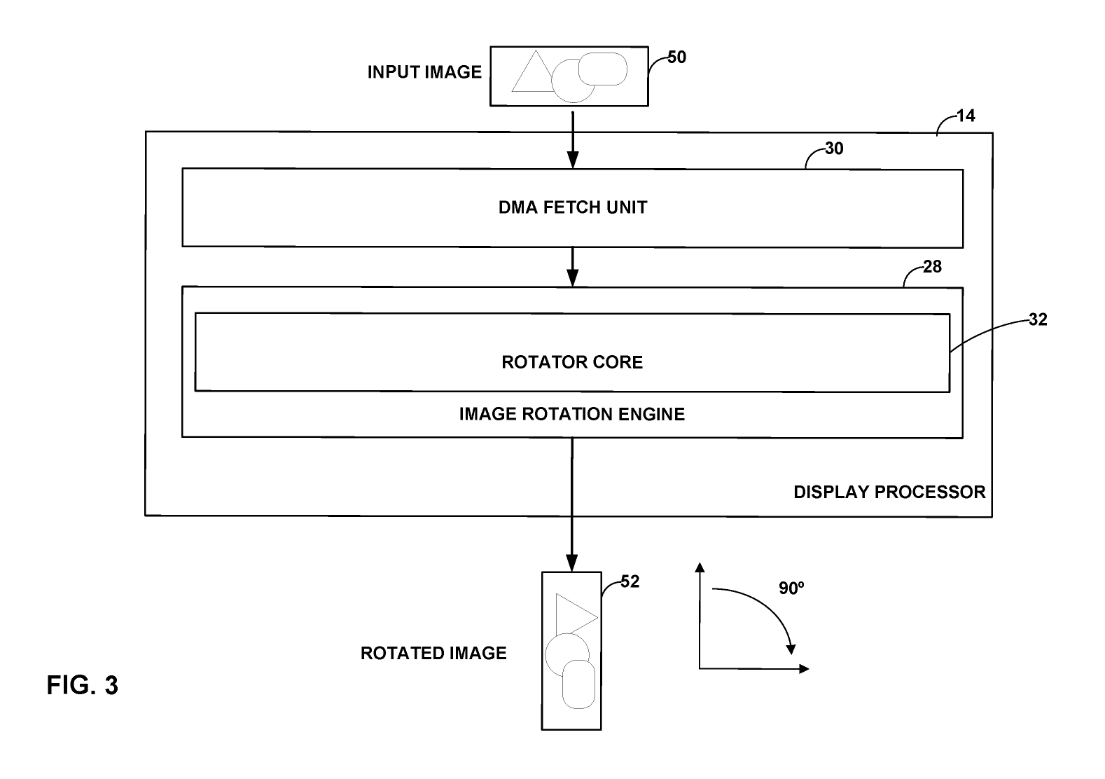

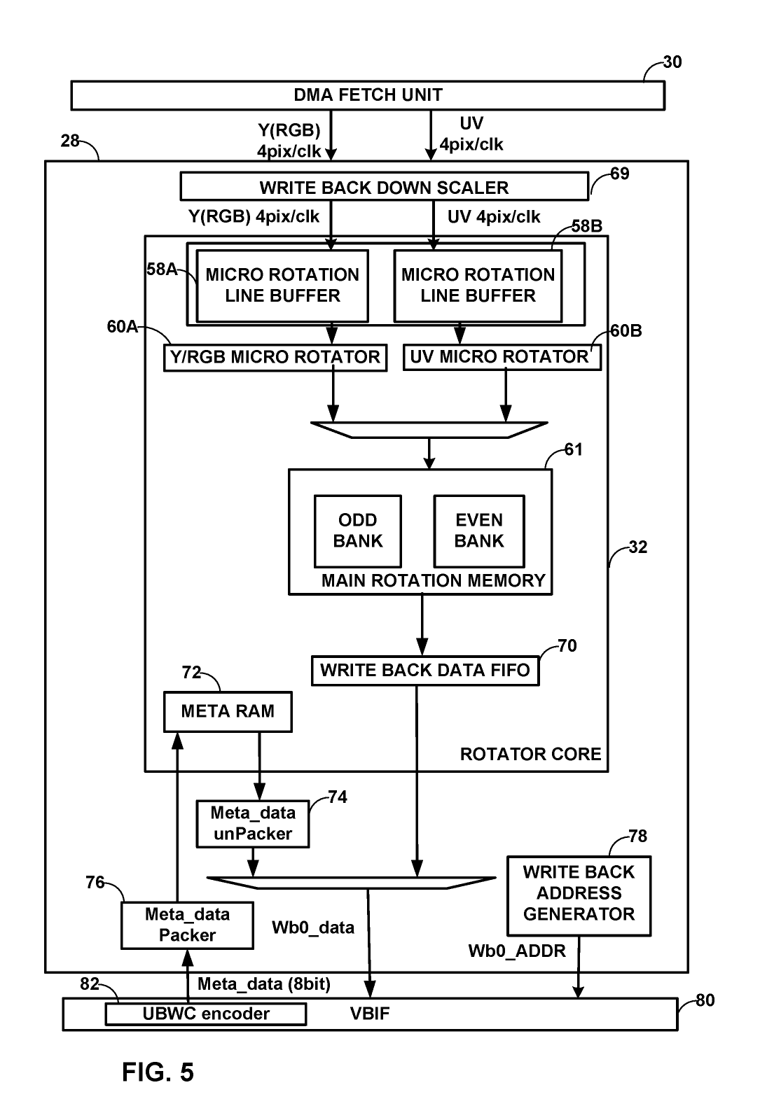

This disclosure proposes devices and techniques for image rotation that may reduce the amount of memory needed to perform rotation, reduce the amount of chip area dedicated to image rotation, and reduce power consumed during image rotation. FIG. 3 is a block diagram illustrating an example display processor 14 that may be configured to implement one or more aspects of this disclosure. As shown in FIG. 3, display processor 14 may be configured to access pixel data for input image 50 and produce rotated image 52. Display processor 14 may include, among other hardware units, a DMA (direct memory access) fetch unit 30 and image rotation engine 28. Image rotation engine 28 may further include a rotator core 32. Rotator core 32 includes the memories and buffers used to perform a portion of the image rotation techniques of this disclosure. Additional details regarding image rotation engine 28 and rotator core 32 will be described below with reference to FIG. 5.

DMA fetch unit 30 fetches pixels values of an input image from a memory (e.g., memory 17 of FIG. 1). Image rotation engine 28 is configured to rotate the image by writing back the pixels fetched by DMA fetch unit 30 to memory 17 in a rotated memory. As will be explained in more detail below, image rotation engine 28 may achieve rotation by writing back pixel values to memory 17 in a different scan order than DMA fetch unit 30 fetched the pixel values.

In general, image rotation engine 28 may be configured to rotate input image 50 on a block-by-block basis. In one example, image 50 may be divided into blocks that are 128×128 pixel blocks. It should be understood that a 128×128 pixel block is only one example, and other sized blocks may be used as would be beneficial for the data format and/or bit depth of input image 50. For example, 128×128 pixels may be beneficial for the NV12 color format, while 96×96 pixel blocks may be beneficial for other color formats. Some example color formats may use Red, Green, Blue, Alpha (RGBA) components for each pixel, where the “RGB” components correspond to color values and the “A” component corresponds to a destination alpha value (e.g., transparency value). As another example, input image 50 may include pixel data according to a YCbCr color format, YUV color format, RGB color format, or according to any other color format.

When determining a block size to use, the minimum on chip memory storage available to image rotation engine 28 of display processor 14 may be considered. The block size may be made to be proportional to the size of the memory available to image rotation engine 28. The block size may also be chosen to maximize the rotation performance and efficiency. Such a requirement may dictate that the block size cannot be too small, as the transfer of very small blocks between DDR memory (e.g., memory 17) and on chip memory of display processor 14 may not be power efficient and may exhibit poor performance. The x and y dimensions of the block may be chosen in such a way that the number pixels in the x dimension matches a DDR efficient data transfer burst length. An example DDR burst transfer length is 128 bytes or 256 bytes. The choice of 128 pixels in the x dimension makes the burst length match the minimal burst length of 128 bytes in most color formats. The following formula gives the relationship of block size and DDR memory burst size:

Block_dimension_X*BYTE_PER_PIXEL=n*DDR_BURST_LENGTH (n>=1)

Block_dimension_X indicates the width of the block. Byte_per_pxel indicates the number of bytes used to indicated each pixel. DDR_BURST_LENGTH indicates the DDR memory burst size.

The block size is preferably chosen to be square because, during the rotation, the x and y dimensions are swapped between the read and write. To make DDR memory (e.g., memory 17) access equally efficient for both the read and write in rotation, the x and y dimensions of the block are preferably the same.

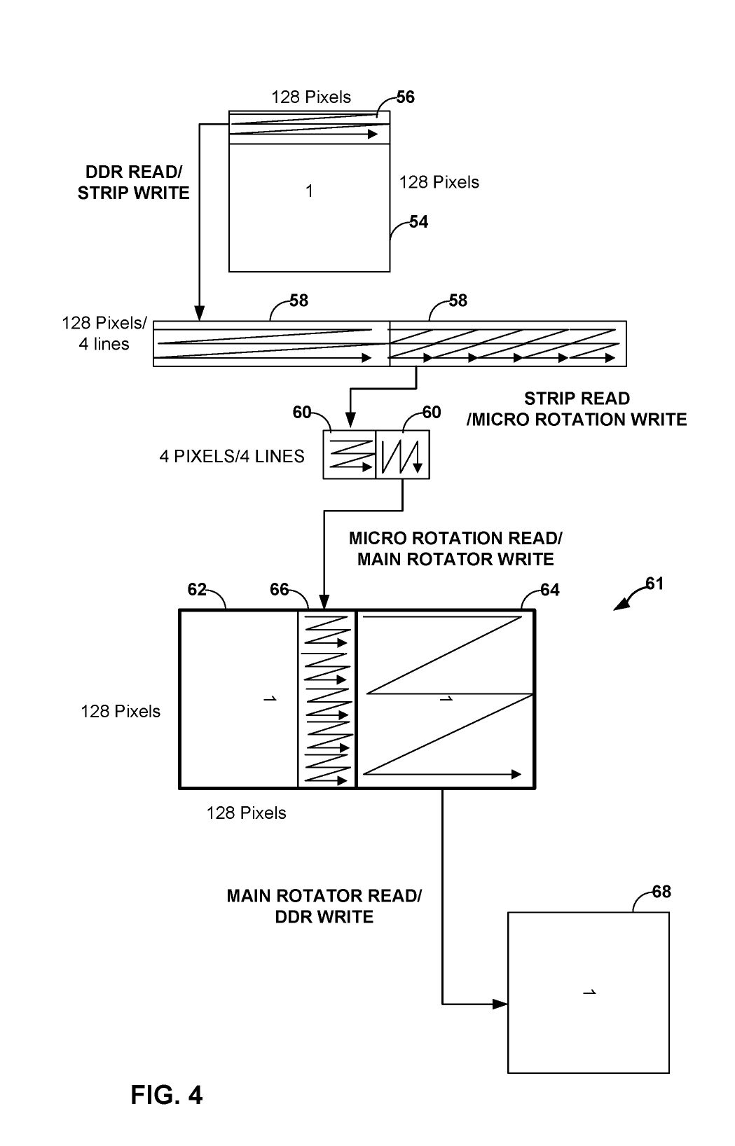

As will be explained in more detail below with reference to FIG. 4, rotation is performed on each block of input image 50 by subdividing the block, first into strips (e.g., 128×4 pixel strips), and then into micro-blocks (e.g., 4×4 pixel micro-blocks). For example, DMA fetch unit 30 may be configured to successively read each strip of a block of input image 50 and store the strip in rotator core 32. Rotator core 32 may then sub-divide the strips into micro-blocks (e.g., 4×4 pixels) and rotate each micro-block of the strip by writing the micro-blocks back into a main rotator memory with a different scan direction than the direction used to store the strips. By dividing the blocks into strips, and then further dividing the strips in to micro-blocks, image rotation engine 28 performs the rotation operation on a small group of pixels. This allows DMA fetch unit 30 to continue to access pixel data from a block at the same time portions of the blocks are being rotated. In addition, image rotation engine 28 may write back rotated blocks into memory 17 while strips and micro-blocks of other blocks are being accessed and rotated. Also, since only small portions of blocks are being rotated at any one time, image rotation engine 28 need not have numerous memory buffers large enough for rotating an entire block of pixels values at one time.

In one example, display processor 14 may be configured to rotate input image 50 at any of the possible 90 degree rotation angles. As is shown in Table 1, with the combination of flip operations performed by DMA fetch unit 30 and a single 90 degree rotation performed by image rotation engine 28, all four desired rotations angles can be supported by the rotation pipe.

TABLE 1
Rotation Angles

| Rotation (degree) | DMA fetch operation | Rotator operation |
|---|---|---|
| 0 | Hflip = 0, Vflip = 0 | No rotation |
| 90 | Hflip = 0, vflip = 0 | Rotate 90 degree |
| 180 | Hflip = 1, vflip = 1 | No rotation |
| 270 | Hflip = 1, vflip = 1 | Rotate 90 degree |

For a 0 degree rotation (i.e., no rotation), DMA fetch unit 30 may be configured to fetch pixel values from input image 50 (e.g., stored in memory 17) using no horizontal flip (Hflip=0) and no vertical flip (Vflip=0). A DMA fetch operation that includes no horizontal flip and no vertical flip may be achieved by accessing pixel data from memory 17 is a horizontal raster scan direction. That is, DMA fetch unit 30 may be configured to access the pixels of a block of input image 50 row-by-row, from left to right, starting at the upper left corner of the block. Image rotation engine 28 would then apply no rotation operation to achieve the desired 0 degree rotation. An access and write back operation with 0 degree rotation may be useful in circumstances where display processor 50 is performing operations other than the rotation on input image 50 (e.g., scaling, compositing, blending, etc.).

For a 90 degree rotation, DMA fetch unit 30 may be configured to fetch pixel values from input image 50 (e.g., stored in memory 17) using no horizontal flip (Hflip=0) and no vertical flip (Vflip=0). Again, DMA fetch unit 30 may fetch the pixels in a horizontal raster scan direction. As will be explained in more detail below, image rotation engine 28 would then apply a 90 degree rotation operation by writing back the pixels of the block in a different scan direction than was used by DMA fetch unit 30 to fetch the pixels.

For a 180 degree rotation, DMA fetch unit 30 may be configured to fetch pixel values from input image 50 (e.g., stored in memory 17) using horizontal flip (Hflip=1) and vertical flip (Vflip=1). A DMA fetch operation that includes both horizontal flip and vertical flip may be achieved by accessing pixel data from memory 17 is a reverse horizontal raster scan direction. That is, DMA fetch unit 30 may be configured to access the pixels of a block of input image 50 row-by-row, from right to left, starting at the lower right corner of the block. Image rotation engine 28 would then apply no rotation operation to achieve the desired 180 degree rotation, as 180 degree rotation was achieved by DMA fetch unit 30 accessing the block pixel values using horizontal and vertical flip.

For a 270 degree rotation, DMA fetch unit 30 may again be configured to fetch pixel values from input image 50 (e.g., stored in memory 17) using horizontal flip (Hflip=1) and vertical flip (Vflip=1). Again, DMA fetch unit 30 may fetch the pixels in a reverse horizontal raster scan direction. Image rotation engine 28 would then apply a 90 degree rotation operation by writing back the pixels of the block in a different scan direction than was used by DMA fetch unit 30 to fetch the pixels.

FIG. 4 is a conceptual diagram illustrating a hierarchical image rotation technique according to one example of this disclosure. It should be noted that the various image blocks, strips, and micro-blocks shown in FIG. 4 are not shown to scale.

In the example of FIG. 4, an image may include a block 54 (e.g., see block 1 of image 50 of FIG. 3). In this example, the block is 128×128 pixels. However, other size blocks may be used. DMA fetch unit 30 may be configured to fetch a pixel strip 56 (e.g., 128×4 pixels) from block 54. Such a fetch operation may be termed a DDR read, as DMA fetch unit 30 may read strip 56 from memory 17 of FIG. 1, which may be implemented as DDR memory. DMA fetch unit 30 may write strip 56 to strip buffer 58 (strip write). The terms strip buffer and micro rotation line buffer may be used synonymously in this disclosure. As used herein, both a strip buffer and a micro rotation line buffer may refer to memory in image rotation engine 28 used to store strips (e.g., 128×4 pixels) of a block of image data. Strip buffer 58 may be implemented as dual ported memory. Dual ported memory includes memory interfaces for both read and writes to the memory. In this way, image data may be written into, and read from, strip buffer 58 at the same time.

As can be seen in FIG. 4, DMA fetch unit 30 may be configured to perform the DDR read and strip write using the same scan direction. In the example of FIG. 4, the scan direction is a horizontal raster scan direction. However, other scan directions may be used, so long as the DDR read and strip write are the same direction.

Once at least one 4×4 micro-block of pixels of strip 56 has been written to strip buffer 58, image rotation engine 28 may be configured to read a 4×4 micro-block of strip 56 from strip buffer 58 (strip read) and write the 4×4 micro-block into micro rotation buffer 60 (micro rotation write). Again, a 4×4 micro-block is only one example. Different micro-block sizes may be used. For example, for a 4×4 micro-block, once the width of the strip write equals the total height of the strip (in this example 4), image rotation engine 28 may perform the micro rotation write. This is possible if strip buffer 58 is implemented as dual ported memory. In this way, a second division of block 54 may start before the entirety of strip 56 is written into strip buffer 58. Such a technique provides for more efficient memory usage, and thus lowers the amount of total memory needed to perform image rotation. Again, the strip read and the micro rotation write are in the same scan direction (e.g., a horizontal raster scan).

The terms micro rotation buffer and micro rotator may be used synonymously in this disclosure. As used herein both a micro rotation buffer and a micro rotator may refer to memory in image rotation engine 28 used to store micro-blocks (e.g., 4×4 pixels) of a strip of image data. In one example of the disclosure, micro rotation buffer 60 may be implemented with flip-flops.

Once micro rotation buffer 60 is full, image rotation engine 28 may read the micro-block of pixels from micro rotation buffer 60 (micro rotation read) and write the pixel values to main rotation memory 61 (main rotator write). Notably, image rotation engine 28 performs the micro rotation read in a different scan direction than was previously used for the strip write and the micro rotation write. As shown in FIG. 4, image rotation engine 28 performs the micro rotation read/main rotator write using a vertical raster scan order. That is, a raster scan order that proceeds downwards in columns, starting at the upper right most pixel. When written to main rotation memory 61, the micro-blocks of horizontal strip 56 are written as micro-blocks of a vertical strip 66, thus achieving a 90 degree rotation. Image rotation engine 28 repeats this process for every micro-block of a strip, and then for every strip of block 54, and eventually every block of image 50.

Main rotation memory 61 may be implemented as single ported memory with a write bank 62 and a read bank 64. In the example of FIG. 4, each of write bank 62 and read bank 64 are configured to store 128×128 pixels worth of data. Single ported memory is simpler than dual ported memory, as single ported memory only has one memory interface. As such, single ported memory may only be used for either write or read operations at a single time. As shown in FIG. 4, write bank 62 is configured for write operations (main rotator write) and read bank 64 is configured for read operations (main rotator read). However, it should be understood that the read and write functionality of write bank 62 and read bank 64 may be swapped back and forth.

When a bank of main rotation memory 61 becomes full (e.g., every micro-block of every strip has been rotated and written into main rotation memory 61), image rotation engine 28 may be configured to read the rotated block 68 from main rotation memory 61 (main rotator read) and write the rotated block 68 to memory 17 (DDR write). Since the pixel values in main rotation memory 61 have already been rotated, the scan direction for DDR write may be the horizontal raster scan order.

FIG. 5 is a block diagram illustrating an image rotation engine according to one example of this disclosure in more detail. As discussed above, in one example, DMA fetch unit 30 and image rotation engine 28 may be implemented in display processor 14. In other examples, DMA fetch unit 30 and image rotation engine 28 may be implemented in other processors, such as DSP 11, video codec 7, and/or GPU 12. In other examples, DMA fetch unit 30 and image rotation engine 28 may be implemented as a stand-alone ASIC. Image rotation engine 32 includes rotator core 32, which comprises the memory units used to perform the hierarchical image rotation techniques of this disclosure.

DMA fetch unit 30 may be configured to fetch pixel values from an image stored in memory (e.g., memory 17 of FIG. 1). In one example, DMA fetch unit may be configured to fetch a strip of pixel values (e.g., 128×4 pixels) of a block (e.g., 128×128 pixels) of an image. In the example of FIG. 4, DMA fetch unit 30 may be configured to fetch certain color components of pixel values in different channels. For example, one channel is configured to fetch and write Y and RGB color components, while another channel is configured to fetch and write UV color components. Each of the channels of color components may first be processed by write back down scaler 69, and then stored in respective micro rotation line buffer 58A (Y(RGB) values) or micro rotation line buffer 58B (UV values). During an image rotation process, display processor may also be configured to downscale the image to a smaller size if the image is too big to fit on the display screen or in some cases, the display image need to be fit into an on-screen window. Write back down scaler 69 may be configured to perform such a downscaling process.

Although the down scaling can be done before or after the rotation. It may be more power and performance optimal if the downscaling is combined with the rotation as a single function. For a block read in by DMA fetch unit 30, write back down scaler 69 may perform a down scaling process before pass the down scaled block to rotator core 32. The down scaling ratio can be ½, ¼, ⅛, 1/16, all the way to 1/128, as well as ⅔. Other down scaling factor can be implemented as well, with more complexity.

As shown in FIG. 4, DMA fetch unit 30 may be configured to access four pixels values per clock cycle. As described above with reference to Table 1, DMA fetch unit 30 is configured to access strips of pixel data from an image in either a horizontal flip or vertical flip fashion.

As described above, with respect to FIG. 4, DMA fetch unit 30 may be configured to fetch data from a block of an image. Such data may be compressed with a data compression technique (e.g., UBWC). To support UBWC compression and decompression, image rotation engine 28 may access UBWC meta data (Meta_data (8 bit) from UBWC encoder 20 via virtual bus interface (VBIF) 80. The UBWC meta data may include data that instructs image rotation engine 28 how to decompress and recompress the UBWC image data. The UBWC meta data may be packed by Meta_data packer 76 for storage in Meta RAM 72. When rotated image data is written back through VBIF 80, meta_data unpacker 74 may unpack the UBWC meta data from meta RAM 72 and send the unpacked UBWC meta data along with the rotated image data. UBWC encoder 82 may be configured to encode pixel data using UBWC compression.

Image rotation engine 28 is configured to rotate and write back image data fetched by DMA fetch unit 30. Image rotation engine 28 may be configured to write back image data in a linear fashion (e.g., line by line) or in UBWC blocks.

Like strip buffer 58 of FIG. 4, micro rotation line buffer 58A and micro rotation line buffer 58B may be configured to store strips of pixel data. In one example, both micro rotation line buffer 58A and micro rotation line buffer 58B are implemented as dual ported memory. The size of the micro rotation line buffer 58A and micro rotation line buffer 58B may be chosen based on the bit depth and size of the images to be rotated, and/or the memory space and area available for computing device. In one example, a “high end” configuration of image rotation engine 32 may implement micro rotation line buffer 58A and micro rotation line buffer 58B with 64 bit/2 Kb dual ported memories. A “low end” configuration of image rotation engine 32 may implement micro rotation line buffer 58A and micro rotation line buffer 58B with 64 bit/1 Kb dual ported memories. However, other memory sizes may be used.

Once at least one micro-block (e.g., 4×4 pixels) of a strip has been stored in micro rotation line buffer 58A or micro rotation line buffer 58B, the micro-block of pixel data may be written to Y/RGB micro rotator 60A and/or UV micro rotator 60B. As discussed above with reference to FIG. 4, micro-blocks of pixels are written into Y/RGB micro rotator 60A and/or UV micro rotator 60B in the same scan direction as the strips of pixel values were written into micro rotation line buffer 58A and micro rotation line buffer 58B.

Image rotation engine 28 reads the micro-blocks in Y/RGB micro rotator 60A and/or UV micro rotator 60B in a different scan direction than was used to write the micro-blocks to Y/RGB micro rotator 60A and/or UV micro rotator 60B. For example, image rotation engine 28 writes the micro-blocks to Y/RGB micro rotator 60A and/or UV micro rotator 60B in a horizontal raster scan order, but reads the micro-blocks from Y/RGB micro rotator 60A and/or UV micro rotator 60B in a vertical raster scan order. By using a different scan order, the micro-blocks are rotated. Image rotation engine 28 writes the micro-blocks read from Y/RGB micro rotator 60A and/or UV micro rotator 60B to main rotation memory 61 in the other raster scan order (e.g., the vertical raster scan order). In this way, the horizontal strips saved in micro rotation line buffer 58A and micro rotation line buffer 58B are written to main rotation memory 61 as vertical strips, one micro-block at a time.

The ODD and EVEN banks in main rotation memory 61 may be implemented as interleaved banks at 16 bytes (e.g., on chip RAM port width 128 bit=16 BYTEs). Such interleaving is used to allow the read and write to main rotation memory 61 to have a throughput of 128 bit per clock. The addressing pattern to main rotation memory 61 may be configured such that when a read occurs to the ODD bank, a write may be made to the EVEN bank. In this way, read and write to main rotation memory 61 may occur on the same clock cycle without any conflict due to the dual bank memory configuration and ODD/EVEN addressing pattern.

Once a full block of image data has been rotated and stored in main rotation memory 61, image rotation engine 28 may write back the rotated block to memory 17. Depending on how the image data is to be stored in memory (e.g., linear storage or UBWC block storage), image rotation engine 28 may read out the contents of main rotation memory 61 into write back data FIFO 70. Write back address generator 78 may control where in memory the rotated image is stored by providing a write back address (Wb0_ADDR) through VBIF 80.

Tables 2 and 3 show example color format support and rotation block size for a high end configuration (Example 1) and a low end configuration (Example 2) of image rotation engine 32. Example 1 may be able to rotate twice the block size, but also uses twice the main rotation memory (32 KB vs. 16 KB). The micro rotation line buffer size is half the size for Example 2. So instead of two 2 KB micro rotation line buffers (as in Example 1), Example 2 uses two 1 KB micro rotation buffer. Example 2 will have less rotation throughput due to smaller block sizes, more block boundaries, and more page misses, as well as smaller memory access burst size in most modes (128B instead of 256B).

For Example 2, in order to not compromise performance for NV12 color modes, the NV12 block size is unchanged. In some examples, it may be expected that most images use NV12 or similar color formats. In order to keep the main rotation memory size to be 16 KB for Example 2, image rotation engine 28 may be configured to perform rotation on one plane at a time (e.g., Y(RGB) or UV) for NV12 instead of rotating two planes at the same time. To rotate one component plane at a time and keep the rotator performance high, pixel throughput for the Y plane may be doubled from 4 pixels/clock to 8 pixels/clock. This will allow single component plane rotation completion in half the time compared to the rotation of two component planes at the same time. As such, two single component planes rotation in succession can complete in the same amount of time as the two component planes rotation at the same time.

TABLE 2
Rotation color format support and rotation block size (Example 1)

| | | | UBWC | |
|---|---|---|---|---|
| Color format | Block size | Linear mode | mode | Notes |
| aRGB8888 | 128 × 128 | Y | Y | * |
| aRGB2101010 | 128 × 128 | Y | Y | * |
| NV12Y | 128 × 128 | Y | Y | |
| NV12UV | 64 × 64 | Y | Y | |
| YUV422 | 128 × 128 | Y | N | |
| P010Y | 128 × 128 | Y | N | * |
| P010UV | 64 × 64 | Y | N | ** |
| RGB565 | 128 × 128 | Y | Y | |

*Hardware split 128 × 128 block into two 128 × 64 blocks and rotate two blocks separately
**Hardware split 64 × 64 blocks into two 64 × 32 blocks and rotate two blocks separately

TABLE 3
Rotation color format support and rotation block size (Example 2)

| | | | UBWC | |
|---|---|---|---|---|
| Color format | Block size | Linear mode | mode | Notes |
| aRGB8888 | 64 × 64 | Y | Y | |
| aRGB2101010 | 64 × 64 | Y | Y | |
| NV12Y | 128 × 128 | Y | Y | * |
| NV12UV | 64 × 64 | Y | Y | * |
| YUV422 | 64 × 64 | Y | N | ** |
| P010Y | 64 × 64 | Y | N | * |
| P010UV | 32 × 32 | Y | N | * |
| RGB565 | 64 × 64 | Y | Y | |

*Hardware rotate Y and UV plane one plane at a time. Hardware processes 8 pixels/clock for Y plane instead of 4 pixels/clock
**May write back two planes concurrently

As described above, image rotation engine 28 performs rotation in two main processes. The first main process may be called micro rotation. During this step, a horizontal strip (4, 6, 8, 12, 16 lines, depending on color format) of a 128×128 rotation block is rotated from horizontal position into vertical position one micro-block at a time (e.g., a 4×4 micro-block). The output of the first step is 128 bit wide strip with a height of final micro-block output. The second main step may be called main rotation, where the vertical strips output from the first step are assembled in main rotation memory 61. The final rotated block is scanned out of main rotation memory 61 in the output image direction.

In summary, in one example of the disclosure, to provide continuous rotation operation, image rotation engine 28 includes a double buffering mechanism provided in both micro rotation line buffer 58A and 58B and main rotation memory 61. The double buffering in both cases may be in place double buffering. In place double buffering is defined as a double buffering technique that functionally provide double buffering, but physically has only a single buffer worth of storage. The in place double buffering is achieved by overlay of two buffers on top of each other in the same piece of memory. As one buffer is reading out the second buffer is using the evicted space in the first buffer to store its data. There may be two read and write patterns when using in place double buffering. The read pattern of the first buffer becomes the write pattern of the second buffer. The read and write address pattern swaps between the two buffers in the storage.

Double buffering may be achieved by reclaiming the buffer entries immediately after they are retired (e.g., written out). Micro rotators 60A and 60B rotates a horizontal strip of an incoming block, one micro-block of the strip at a time. Micro rotators 60A and 60B may rotate a horizontal strip of an incoming block 90 degrees to produce a vertical strip. Micro rotation line buffer 58A and 58B store the incoming video lines. When the line store is equal to the strip height (e.g., one 4×4 micro-block of pixel values are stored in micro rotation line buffer 58A or 58B, the micro rotators 60A or 60B start rotation operation on the current strip to convert the horizontal strip to a vertical strip.

In one example, the micro rotation is performed at a throughput of 4 pixels/clock for both data planes. In one example, in the case of dual plane data format, each plane may use a single 64 bit dual ported memory to read and write data. The 64 bit port width can provide enough bandwidth for a 4 pixel/clock throughput for this dual plane mode. For single plane data format, such as aRGB8888/aRGB2101010, 4 pixels throughput may use a 128 bit memory port width. In single plane data format, two micro rotation line buffers may be combined together to form a single 128 bit dual ported memory.

Double buffering may also be used in micro rotation line buffer 58A and 58B. With double buffering, when one strip is reading out of micro rotation line buffer 58A or 58B, the second strip is storing into the buffer. The double buffering provides continuous operation of the micro rotation. The double buffering mechanism in the micro rotators 60A or 60B is called in place double buffering. Double buffering may be achieved by overlaying the two micro rotation line buffers into the same memory storage. In some data formats, the storage is big enough to hold two strips; in such a case, simple non memory overlapping double buffering may be used.

TABLE 4
Micro rotation line buffer table for different color format (Example 1)

| | | Single | X- | | |
|---|---|---|---|---|---|
| | port | buffer | Dimension | Y- | Double |
| | width | size | (port | Dimension | buffer |
| Color format | (bit) | (KB) | width) | (line) | method |
| aRGB8888 | 128 | 2 | 32 | 4 | Simple |
| aRGB2101010 | 128 | 2 | 32 | 4 | Simple |
| NV12Y | 64 | 2 | 16 | 16 | In place |
| NV12UV | 64 | 1 | 16 | 8 | simple |
| YUV22Y | 64 | 2 | 16 | 16 | In place |
| YUV422UV | 64 | 1 | 16 | 8 | Simple |
| P010Y | 64 | 2 | 32 | 8 | Simple* |
| P010UV | 64 | 1 | 32 | 4 | Simple |
| RGB565 | 64 | 2 | 32 | 8 | Simple |

*second 2 KB buffer is using meta data buffer as P010 does not have meta data

TABLE 5
Micro rotation line buffer table for different color format (Example 2)

| | | | X- | | |
|---|---|---|---|---|---|
| | | Single | Dimension | Y- | Double |
| | port width | buffer | (port | Dimension | buffer |
| Color format | (bit) | size(KB) | width) | (line) | method |
| aRGB8888 | 128 | 1 | 16 | 4 | Simple |
| aRGB2101010 | 128 | 1 | 16 | 4 | Simple |
| NV12Y | 64 | 2 | 16 | 16 | In place |
| NV12UV | 64 | 1 | 16 | 8 | simple |
| YUV22Y | 64 | 1 | 8 | 16 | Simple |
| YUV422UV | 64 | 0.5 | 8 | 8 | Simple |
| P010Y | 64 | 1 | 16 | 8 | Simple |
| P010UV | 64 | 0.5 | 16 | 4 | Simple |
| RGB565 | 64 | 1 | 16 | 8 | Simple |

Main rotation is an operation of collecting vertical strips from micro rotators 60A or 60B and storing them main rotation memory 61. When all the strips of a block are stored in main rotation memory 61 (or, in one example, when a whole block minus the last strip of the block is stored), main rotation memory may scan out the rotated block and write back the rotate block to DDR memory (e.g., memory 17). Main rotation memory 61 may also provide a double buffering mechanism to maintain continuous operation of the rotation. With double buffering, main rotation memory 61 may scan one block out while another block is being stored in main rotation memory 61.

In many use cases, main rotation memory 61 may use in-place double buffering (e.g., one block worth of storage is provided). Main rotation memory 61 buffers a second block using the memory locations that the first block is evicting. In several color formats, when there is enough storage available, a simple double buffering (that is, each block takes a complete different section of the memory) mechanism is also used. In one example, the throughput of main rotation memory 61 is, on the write side, 4 pixels/clock. On the read side, the throughput of main rotation memory may be 128 bit/clock burst throughput.

In one example, the main rotation buffer may use two banks of 128 bit single ported memory to emulate dual ported operation. Both the read port and write port access memory in an ODD/EVEN (OE) bank pattern. In one example, read operations have priority. A write will be forced into the opposite ODD/EVEN phase of the read. The dual bank of 128 bit memory can provide 128 bit/clock throughput for both read and write.

To achieve sustained 128 bit/clock throughput, write back data FIFO 70 (e.g., up to 128B) may be used to smooth out the OE pattern, which changes polarity between lines. An input write FIFO (up to 128B) may also be used to smooth out the input data pattern change. If the memory pattern is EO, the input FIFO should swap the EO before writing to memory 17. For a dual plane color format, main rotation memory 61 may be evenly divided into two sections. For example, a first section for Y values and second section for UV values. The write to main rotation memory 61 may be arbitrated between Y and UV. The arbitration may be performed at the OE pair boundary.

TABLE 6
Main rotator buffer strip patterns for supported color format
(Example 1)

| | Output Block | Block | | |
|---|---|---|---|---|
| | size (x, y) × | memory | No. | Double buffering |
| Color format | Subbloks | size (KB) | Strips | method |
| aRGB8888 | (64 × 128) × 2* | 32 | 16 | In Place |
| aRGB2101010 | (64 × 128) × 2* | 32 | 16 | In Place |
| NV12Y | 128 × 128 | 16 | 8 | In Place |
| NV12UV | 64 × 64 | 8 | 8 | Simple |
| YUV422Y | 128 × 128 | 16 | 8 | In place |
| YUV422UV | 128 × 64 | 16 | 8 | In place |
| P010Y | (64 × 128) × 2* | 16 | N | In Place |
| P010UV | (32 × 64) × 2** | 8 | N | Simple |
| RGB565 | 128 × 128 | 32 | Y | In Place |

*Hardware split 128 × 128 block into two 128 × 64 block and rotate two block separately
**Hardware split 64 × 64 block into two 64 × 32 block and rotate two block separately

TABLE 7
Main rotator buffer strip patterns for supported color format
(Example 2)

| | Output Block | Block | | Double |
|---|---|---|---|---|
| | size (x, y) × | memory | No. | buffering |
| Color format | Subbloks | size (KB) | Strips | method |
| aRGB8888 | (64 × 64) | 16 | 8 | In Place |
| aRGB2101010 | (64 × 64) | 16 | 8 | In Place |
| NV12Y | 128 × 128 | 16 | 8 | In Place |
| NV12UV | 64 × 64 | 8 | 8 | Simple |
| YUV422Y | 64 × 64 | 4 | 4 | Simple |
| YUV422UV | 64 × 32 | 4 | 8 | Simple |
| P010Y | (64 × 64) | 8 | 8 | Simple |
| P010UV | (32 × 32) | 4 | 8 | Simple |
| RGB565 | 64 × 64 | 8 | 8 | Simple |

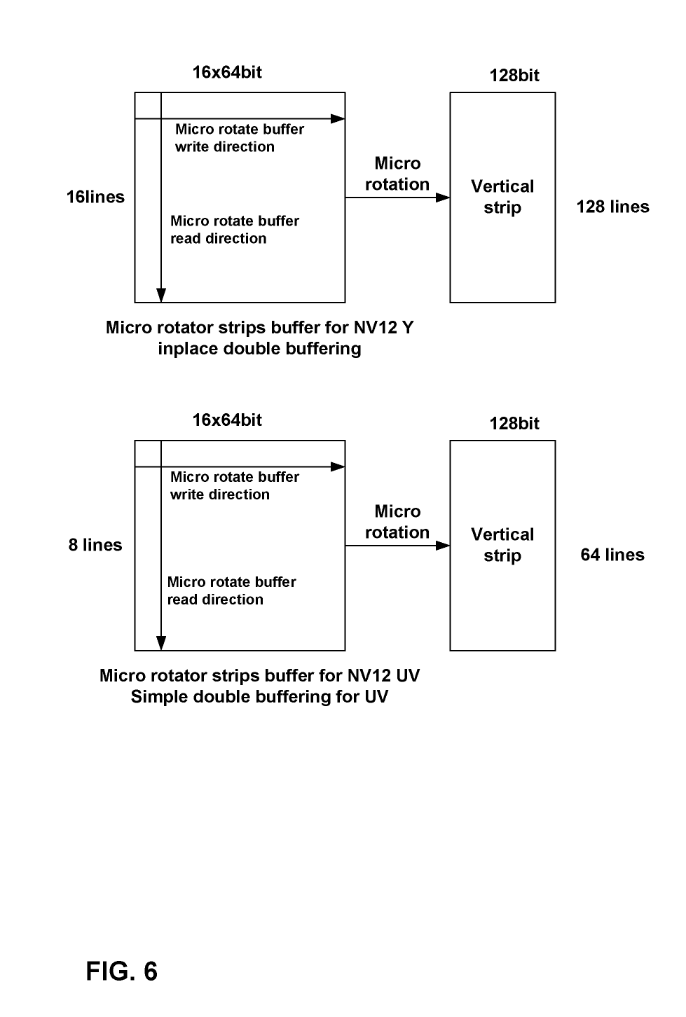

FIG. 6 is a conceptual diagram illustrating example micro rotation read and write directions for NV12 data. FIG. 6 shows the configuration of micro rotation line buffers 58 and an example addressing pattern for NV12 color format. For NV12, there are two color planes, one for Y and one for UV. Each color plane has its own micro rotation line buffer.

The Y micro rotation line buffer may be configured store a strip of 128 pixels by 16 lines of a block at a time, with a total storage of 2 KB. In place double buffering is used to provide double buffering at strip level. There may be two address patterns for in place double buffering. The first pattern is a write pattern in the X direction and a read pattern in the Y direct. The second address pattern is a write pattern in the Y direction and a read pattern in X direction. The two strips in the micro rotation line buffer alternatively use the two addressing pattern for read and write. That is, if the first strip in the micro rotation line buffer uses the first addressing pattern, the second strip being stored into the micro rotation line buffer uses the second pattern, and the third strip being stored in the micro rotation line buffer uses the first data pattern again, and so on.

The UV micro rotation line buffer is configured to store the same amount of pixel data as the Y micro rotation line buffer, since for NV12, UV is subsampled in both the x and y dimension. The UV micro rotation line buffer may be configured to store two strips of pixel data for the same number of pixels of the Y strip. Simple double buffering is used for the UV micro rotation line buffer; one strip uses half of the storage and the second micro rotation line buffer uses the second half of the storage. In simple double buffering, only a single addressing pattern is used. For example, write in the X direction and read in the Y direction is used.

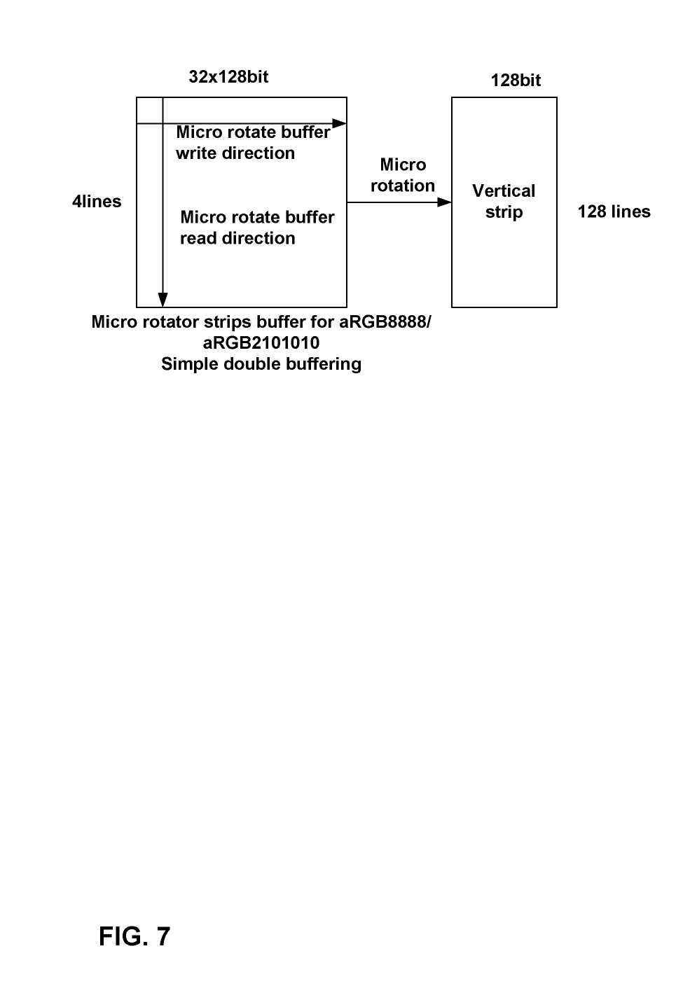

FIG. 7 is a conceptual diagram illustrating example micro rotation read and write directions for aRGB data. For the aRGB color format, the micro rotation line buffer is configured to store a strip of 4 lines. The two micro rotation line buffers 58 are combined to form a single micro rotation line buffer. In this example, the port width of the micro rotation line buffer is 128 bits. The total buffer storage is 4 KB in total. In this example, each strip uses a storage of 2 KB (128×4×4). As such, a simple double buffering mechanism is used for aRGB color format as the storage is big enough to store two strips of aRGB data. A single read and write address pattern is used for aRGB color format for the micro rotation line buffer.

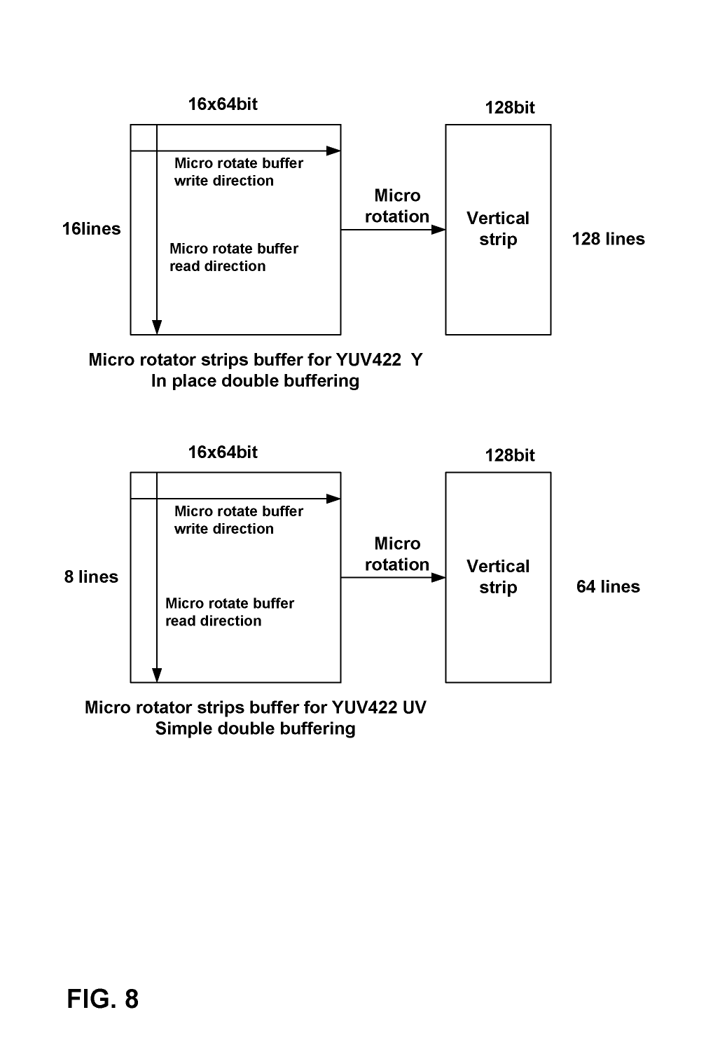

FIG. 8 is a conceptual diagram illustrating example micro rotation read and write directions for YUV422 data. For the YUV422 color format, although the original data is a single plane data format, the rotated data is converted into a two plane format (separate Y and UV). The micro rotation line buffers 58 are separated into Y and UV, and the rotation is performed separately on the Y and UV planes. The Y plane micro rotation line buffer is the same configuration as the NV12 Y micro rotation line buffer and the UV plane micro rotation line buffer is the same configuration as the NV12 UV micro rotation line buffer.

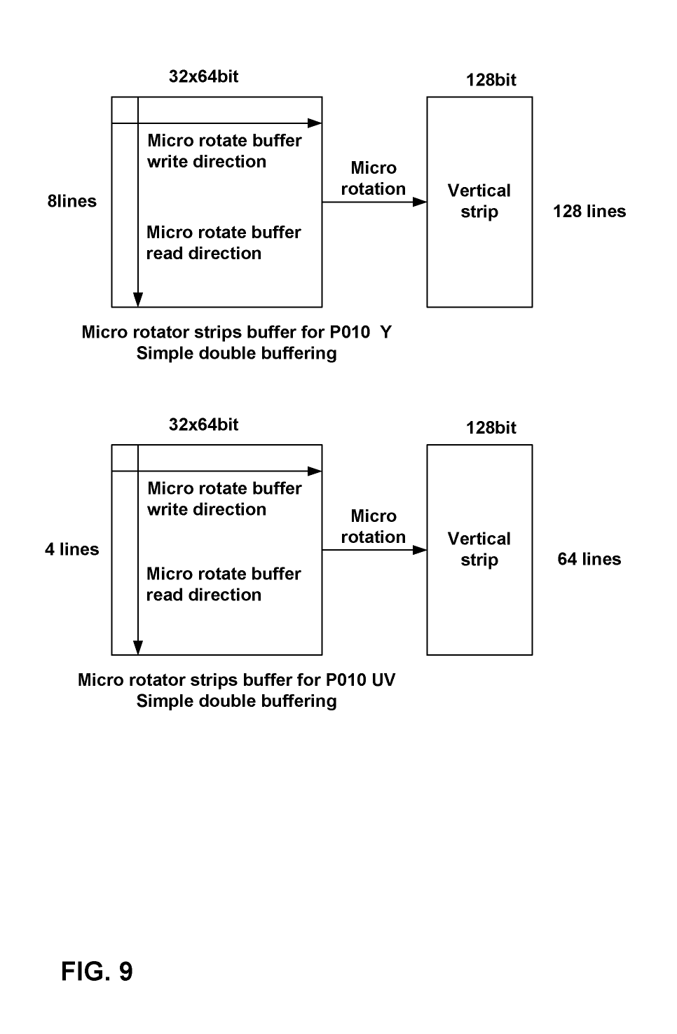

FIG. 9 is a conceptual diagram illustrating example micro rotation read and write directions for P010 data. P010 is a two plane color format. For the P010 color format, the micro rotation line buffer 58 are configured as separate for Y and UV. In this example, for the Y plane, the strip is 8 lines in height. In this example, a single strip takes 2 KB (128×2×8) of storage. In place double buffering is used for two strips to double buffer inside the micro rotation line buffer. Two addressing pattern are used alternatively between the two strips. For the UV plane, due to horizontal and vertical sub sampling, the same strip size as Y in pixels for UV takes half the storage (1 KB). A simple double buffering mechanism, with each strip taking each half of the storage, is used to achieve strip double buffering.

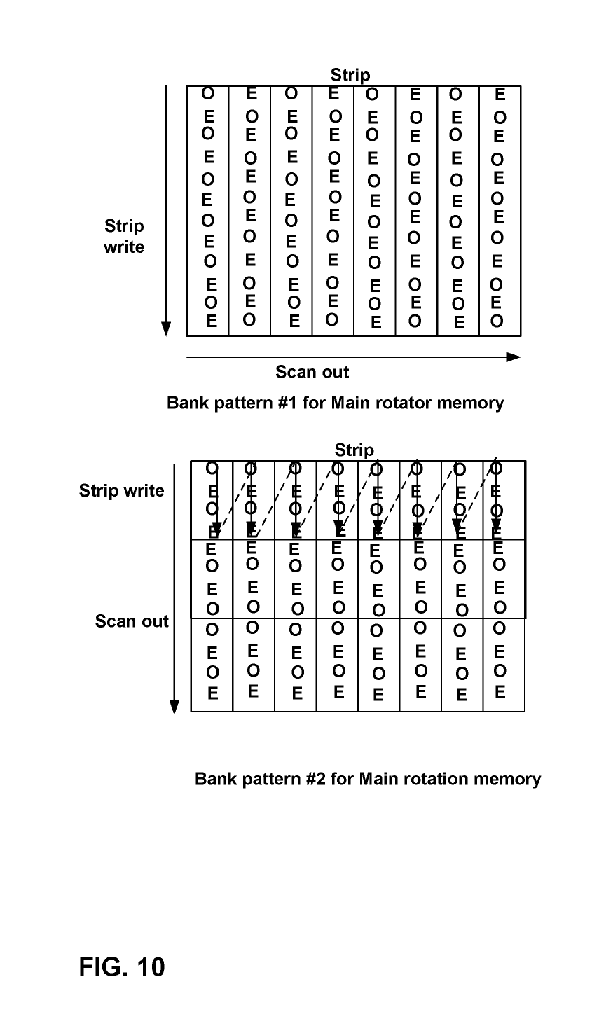

FIG. 10 is a conceptual diagram illustrating read and write directions for a main rotator buffer. FIG. 10 shows the read and write addressing pattern for main rotation memory 61. The fine addressing pattern is divided into ODD and EVEN addresses at the 128 bit (16 Byte) level. The addressing in both X and Y dimension is ODD and EVEN address interleaved. This arrangement of addresses allows the read and write processes to be able access main rotation memory 61 every color cycle as long as the read and write following ODD/EVEN address. As the general read and write pattern in main rotation memory 61 is read horizontal and write vertical, a checkerboard ODD/EVEN pattern make both read and write follow the ODD/EVEN address pattern.

The two main address walking patterns shown in FIG. 10 illustrate the in place double buffering mechanism used for main rotation memory 61. Main rotation memory 61, in most color formats, has the storage capacity of a single rotation block or, in the extreme case, half a rotation block. Double buffering may be achieved at the block level by using two orthogonal address pattern for each of the double buffered blocks. That is, a first block is read into main rotation memory 61 using the first data pattern, a second block is read into main rotation memory 61 using the second data pattern, and a third block is read into main rotation memory 61 uses the first addressing pattern again, and so on.

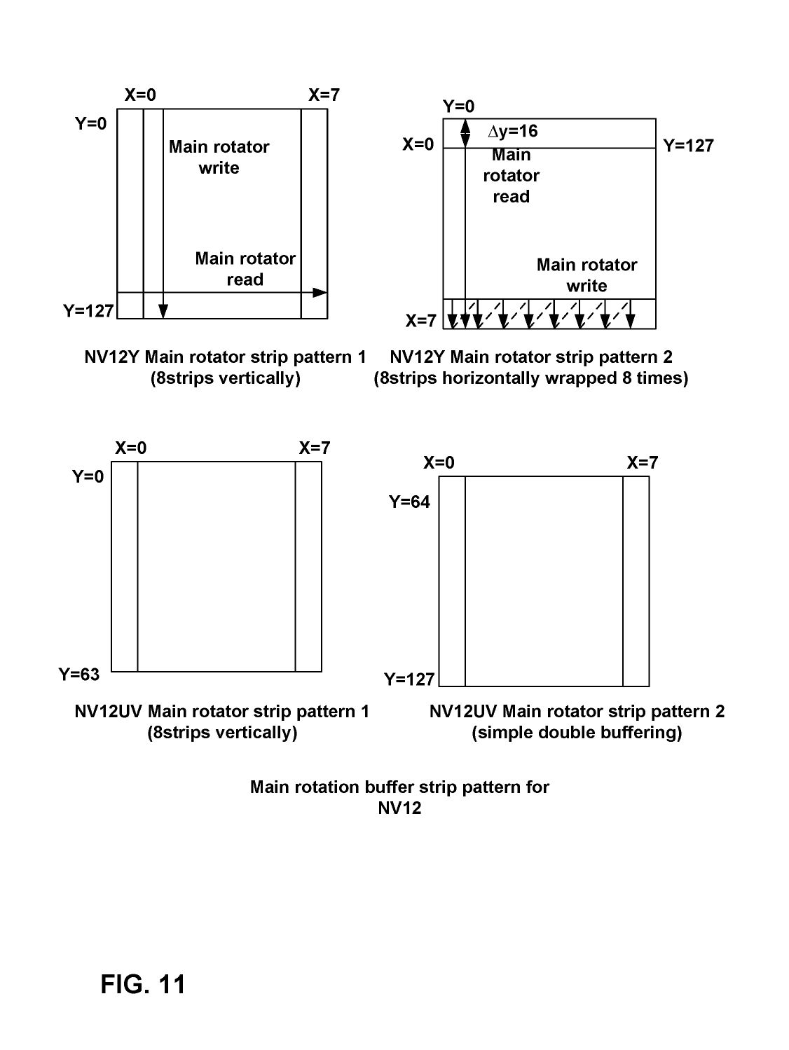

FIG. 11 is a conceptual diagram illustrating example main rotation memory read and write directions for NV12 data. NV12 is a dual plane color format, main rotation memory 61 is logically divided into two equally sized buffers; half for Y and half for UV. In this example, each half of main rotation memory 61 has a storage of 16 KB. For the Y plane, 16 KB of storage can only store a single block (128 pixels×128 lines×1 B/pixel=16 KB). In place double buffering is used to achieve double buffering for main rotation memory 61. Two address pattern are shown in FIG. 11. The first pattern is a vertical write and a horizontal read, and the second pattern is a horizontal write and a vertical read. The two double buffering blocks in main rotation memory 61 use the two addressing patterns alternately.

For the UV plane, due to pixel subsampling in both the x and the y dimensions, the storage of a block for UV plane is 8 KB. 16 KB storage is assigned for the UV plane, such that main rotation memory 61 can store two blocks of UV data. A simple double buffer mechanism is used for UV plane. A single addressing pattern for a UV block is used (e.g., write vertical and read horizontal).

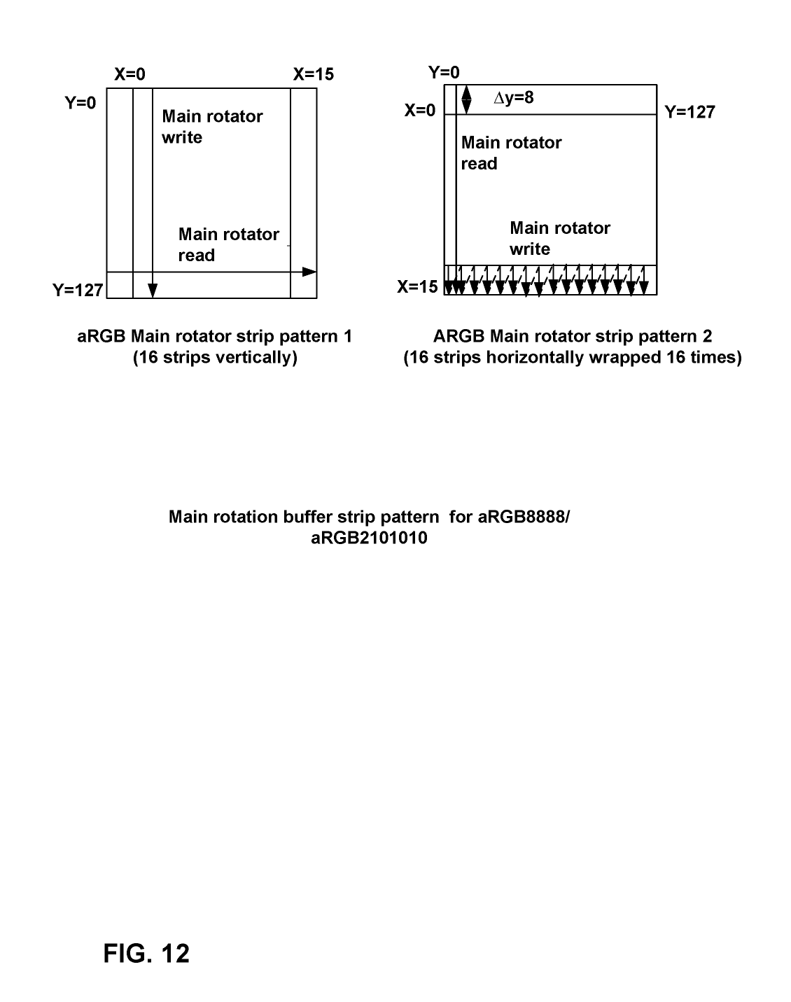

FIG. 12 is a conceptual diagram illustrating example main rotation memory read and write directions for aRGB data. The aRGB color format is a single plane color format. In this example, the entire 32 KB main rotation memory 61 storage is assigned to a block. In this example, the block size for aRGB is actually 64 KB (128 pixels×128 lines×4 Byte/pixel=64 KB). As such, the 32 KB storage can only store half a block. As such, in this example, the double buffering is between the two half blocks. The double buffering mechanism is in place double buffering, as only a single half block storage is available. Two address patterns for each of the in place double buffering is shown FIG. 12. The first pattern is a vertical write and a horizontal read, and the second addressing patter is a horizontal write and a vertical read. The first half of the aRGB block uses the first addressing pattern and the second half of the aRGB block uses the second addressing pattern.

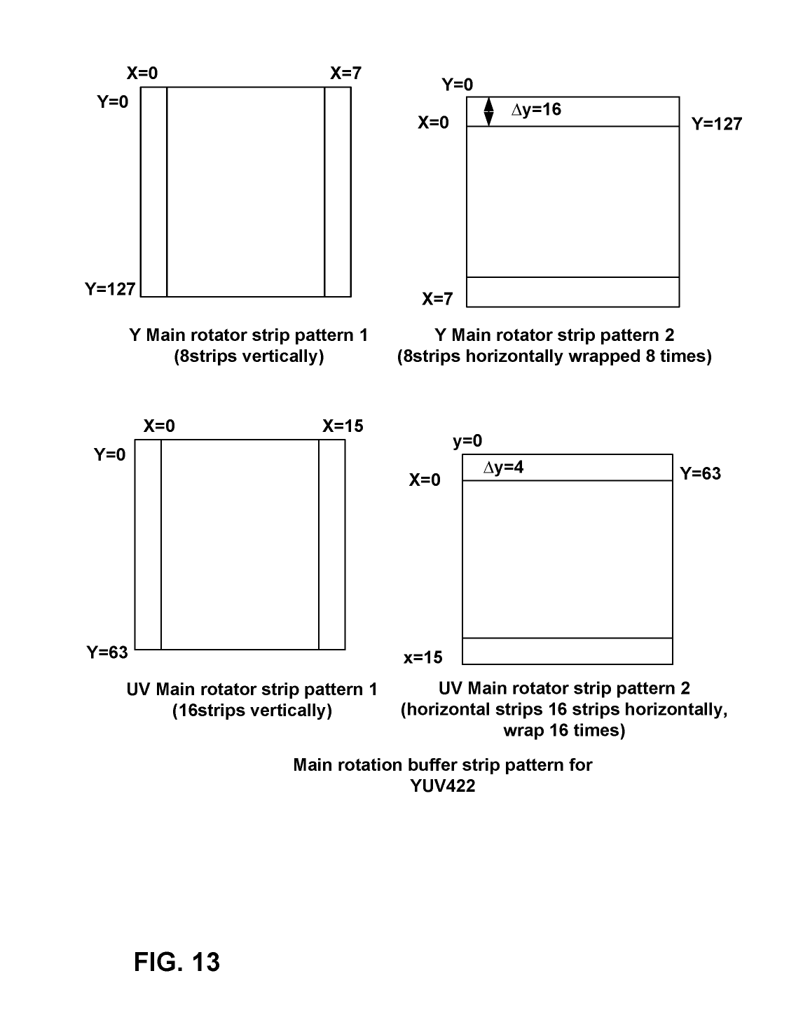

FIG. 13 is a conceptual diagram illustrating example main rotation memory read and write directions for YUV422 data. The YUV422 color format rotation output is a dual plane format. Main rotation memory 61 for the Y plane is configured the same as for the NV 12 Y plane. The double buffering mechanism for the UV plane is in place double buffering. The UV plane block size is the same as the Y plane buffer size, as only one horizontal subsampling is used (i.e., there is no vertical sub-sampling for YUV422). In this example, the UV block size is 16 KB. In place double buffering is used due to UV storage being only 16 KB in this example. FIG. 13 shows the two addressing pattern of the in place double buffering for YUV422 UV plane.

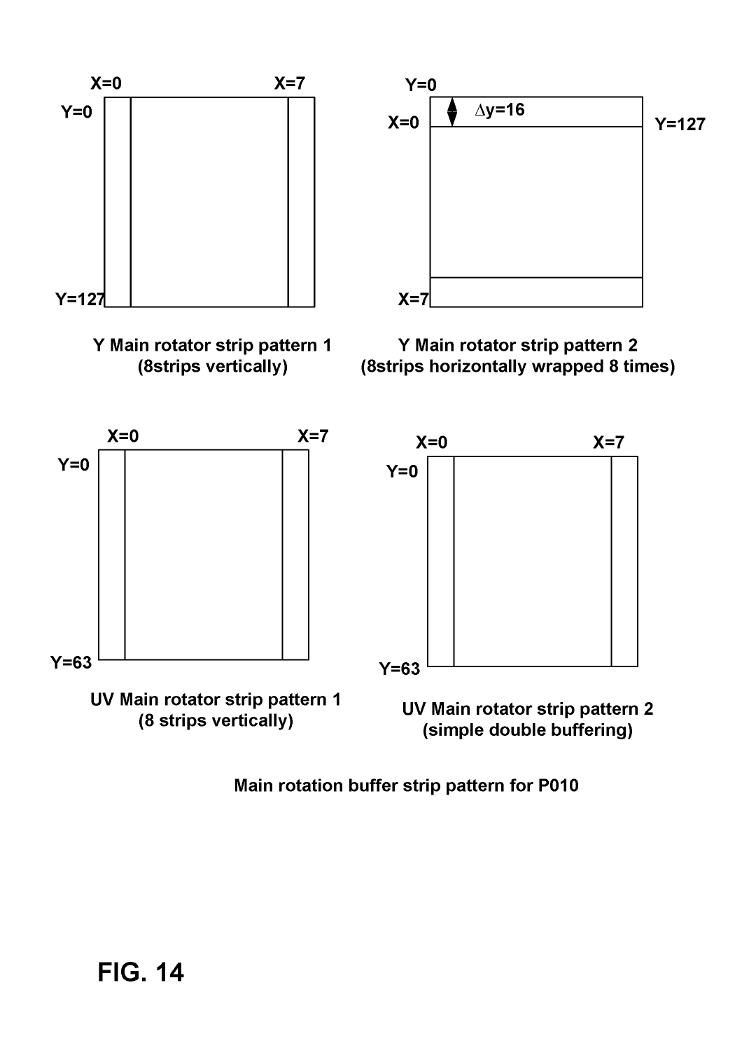

FIG. 14 is a conceptual diagram illustrating example main rotation memory read and write directions for P010 data. P010 is a dual plane color format. In this example, the Y plane block size is 32 KB (128 pixels×128 lines×2 Byte/pixel=32 KB). The main rotation memory 61 storage for the P010 Y plane is 16 KB, which is half the block size. The double buffering mechanism is achieved using in place double buffering between the two half blocks.

The UV plane, due to pixel sub sampling in both horizontal and vertical direction, has a 16 KB storage requirement for a block, in this example. The double buffering used is a simple double buffering mechanism for the UV block. Each buffer of main rotation memory 61 is for half a UV block. The double buffering addressing pattern is shown in FIG. 14 for the UV plane.

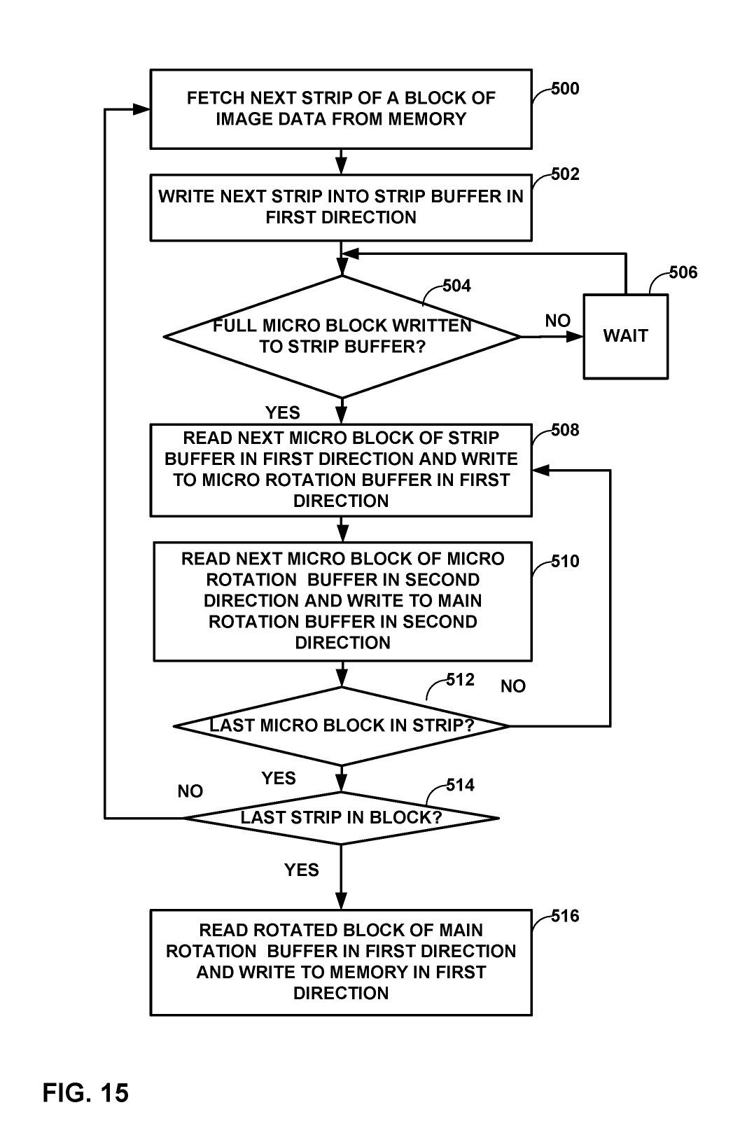

FIG. 15 is a flowchart illustrating an example method according to one or more aspects of the disclosure. The techniques of FIG. 15 may be implemented by display processor 14, including image rotation engine 28 (e.g., as shown in FIG. 1 and FIG. 5). Display processor 14 may be configured to fetch the next strip of a block of image data from memory 17 (500). Image rotation engine 28 may be configured to write the next strip into a strip buffer (e.g., micro rotation line buffers 58) in a first direction (502).

Image rotation engine 28 may then determine if a full micro block has been written to the strip buffer (504). If no, image rotation engine 28 waits until a full micro block has been written to the strip buffer (506). If yes, image rotation engine 28 reads the next micro block of the strip buffer in a first direction and writes the micro block to the micro rotation buffer (e.g., micro rotators 60 of FIGS. 4 and 5) in the first direction (508.) Image rotation engine 28 then reads the next micro block of the micro rotation buffer in a second direction and writes the micro block to a main rotation buffer (e.g., main rotation memory 61) in a second direction (510).

Image rotation engine 28 then determines if the rotated micro block is the last micro block in the strip (512). If no, image rotation engine 28 repeats steps (508) and (510) for the next micro block in the strip. If yes, then image rotation engine 28 determines if the rotated strip is the last strip in the block (514). If no, image rotation engine 28 repeats all of steps (500)-(512). If yes, image rotation engine 28 reads the rotated block in the main rotation buffer in the first direction and writes to the external memory (e.g., memory 17) in the first direction (516).

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described may be implemented in hardware, software, firmware, or any combination thereof. For example, although the term “processing unit” has been used throughout this disclosure, it is understood that such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

What is claimed:

1. A method for processing image data, the method comprising:
fetching a strip of a block of image data from an external memory;
writing the strip into a strip buffer in a first scan direction;
reading a micro-block of pixels of the strip in the strip buffer in the first scan direction and writing the micro-block into a rotation buffer in the first scan direction; and
rotating the micro-block of pixels by reading the micro-block of pixels in the rotation buffer in a second scan direction, the second scan direction being different from the first scan direction, and writing the micro-block of pixels into a rotation memory in the second scan direction.

2. The method of claim 1, wherein reading the micro-block of pixels of the strip in the buffer begins when one micro-block of pixels has been written to the strip buffer.

3. The method of claim 1, further comprising:
repeating the method of claim 1 for every micro-block of pixels of the strip.

4. The method of claim 3, further comprising:
repeating the method of claim 3 for every strip of the block.

5. The method of claim 4, further comprising:
beginning reading the pixels from the rotation memory when all but one strip of the block has been rotated and written to the rotation memory; and
writing rotated pixels of the block from the rotation memory back to the external memory.

6. The method of claim 5, further comprising:
repeating the method of claim 5 for every block of the image data.

7. The method of claim 1, wherein the strip buffer is dual ported memory, wherein the rotation buffer comprises flip-flops, and wherein the rotation memory is single ported memory.

8. An apparatus configured to process image data, the apparatus comprising:
an external memory configured to store image data; and
a display processor comprising a strip buffer, a rotation buffer, and a rotation memory, the display processor configured to:
fetch a strip of a block of the image data from the external memory;
write the strip into the strip buffer in a first scan direction;
read a micro-block of pixels of the strip in the strip buffer in the first scan direction and write the micro-block into the rotation buffer in the first scan direction; and
rotate the micro-block of pixels by reading the micro-block of pixels in the rotation buffer in a second scan direction, the second scan direction being different from the first scan direction, and write the micro-block of pixels into the rotation memory in the second scan direction.

9. The apparatus of claim 8, wherein the display processor is further configured to read the micro-block of pixels of the strip in the buffer when one micro-block of pixels has been written to the strip buffer.

10. The apparatus of claim 8, wherein the display processor is configured to repeat the fetch, write, read and write, and rotate and write processes of claim 8 for every micro-block of pixels of the strip.

11. The apparatus of claim 10, wherein the display processor is configured to repeat the process of claim 8 for every strip of the block.

12. The apparatus of claim 11, wherein the display processor is further configured to:
begin reading the pixels from the rotation memory when all but one strip of the block has been rotated and written to the rotation memory; and
write rotated pixels of the block from the rotation memory back to the external memory.

13. The apparatus of claim 12, wherein the display processor is configured to repeat the process of claim 12 for every block of the image data.

14. The apparatus of claim 8, wherein the strip buffer is dual ported memory, wherein the rotation buffer comprises flip-flops, and wherein the rotation memory is single ported memory.

15. The apparatus of claim 8, wherein the apparatus is an integrated circuit.

16. The apparatus of claim 8, wherein the apparatus is one of a tablet computer, mobile communication device, laptop computer, or desktop computer.

17. An apparatus configured to for process image data, the apparatus comprising:
means for fetching a strip of a block of image data from an external memory;
means for writing the strip into a strip buffer in a first scan direction;
means for reading a micro-block of pixels of the strip in the strip buffer in the first scan direction;
means for writing the micro-block into a rotation buffer in the first scan direction;
means for rotating the micro-block of pixels by reading the micro-block of pixels in the rotation buffer in a second scan direction, the second scan direction being different from the first scan direction; and
means for writing the micro-block of pixels into a rotation memory in the second scan direction.

18. The apparatus of claim 17, wherein the means for reading the micro-block of pixels of the strip in the buffer begins reading the micro-block of pixels when one micro-block of pixels has been written to the strip buffer.

19. The apparatus of claim 17, wherein the apparatus is configured to repeat the functions of claim 17 for every micro-block of pixels of the strip.

20. The apparatus of claim 19, wherein the apparatus is configured to repeat the functions of claim 19 for every strip of the block.

21. The apparatus of claim 20, further comprising:
means for beginning reading the pixels from the rotation memory when all but one strip of the block has been rotated and written to the rotation memory; and
means for writing rotated pixels of the block from the rotation memory back to the external memory.

22. The apparatus of claim 21, wherein the apparatus repeats the functions of claim 21 for every block of the image data.

23. The apparatus of claim 17, wherein the strip buffer is dual ported memory, wherein the rotation buffer comprises flip-flops, and wherein the rotation memory is single ported memory.

24. A computer-readable storage medium storing instructions that, when executed, cause one or more processors of a device for processing image data to:
fetch a strip of a block of image data from an external memory;
write the strip into a strip buffer in a first scan direction;
read a micro-block of pixels of the strip in the strip buffer in the first scan direction and write the micro-block into a rotation buffer in the first scan direction; and
rotate the micro-block of pixels by reading the micro-block of pixels in the rotation buffer in a second scan direction, the second scan direction being different from the first scan direction, and write the micro-block of pixels into a rotation memory in the second scan direction.

25. The computer-readable storage medium of claim 24, wherein the instructions cause the one or more processors to read the micro-block of pixels of the strip in the buffer when one micro-block of pixels has been written to the strip buffer.

26. The computer-readable storage medium of claim 24, wherein the instructions further cause the one or processor to:
repeating the processes of claim 24 for every micro-block of pixels of the strip.

27. The computer-readable storage medium of claim 26, wherein the instructions further cause the one or processor to:
repeating the processes of claim 26 for every strip of the block.

28. The computer-readable storage medium of claim 27, wherein the instructions further cause the one or processor to:
begin reading the pixels from the rotation memory when all but one strip of the block has been rotated and written to the rotation memory; and
write rotated pixels of the block from the rotation memory back to the external memory.

29. The computer-readable storage medium of claim 28, wherein the instructions further cause the one or processor to:
repeating the processes of claim 28 for every block of the image data.

30. The computer-readable storage medium of claim 24, wherein the strip buffer is dual ported memory, wherein the rotation buffer comprises flip-flops, and wherein the rotation memory is single ported memory.
